(19) United States
(12) Patent Application Publication
(10) Pub. No.: US 2019/0178021 A1
(43) Pub. Date: Jun. 13, 2019

(54) Use of Motion to Disguise a Locking Cabinet / Safe

(71) Applicant: Nick Kohli, Wallkill, NY (US)

(72) Inventor: Nick Kohli, Wallkill, NY (US)

(21) Appl. No.: 15/837,245

(22) Filed: Dec. 11, 2017

(51) Int. Cl. E05G 1/02; A47B 51/00; A47B 55/00

(52) U.S. Cl. CPC E05G 1/02; E05G 1/06; A47B 55/00; A47B 51/00

(57) ABSTRACT

A method to conceal a locking safe in a furniture piece is provided. A lifting device is positioned within a hollow furniture piece. A locking safe is positioned on a platform of the lifting device wherein the locking safe is concealed within the hollow furniture piece. The locking safe is covered with a top of the hollow furniture piece. The lifting device is signaled to raise the locking safe to a position above the hollow furniture piece. A lock on a surface of the locking safe is opened to access the contents. The lifting device is signaled to lower the locking safe into a concealed position within the hollow furniture piece.

### (1) TECHNICAL FIELD

The disclosure relates to locking cabinets or safes, and more particularly, to disguising a locking cabinet or safe.

### (2) BACKGROUND

Safes or locking cabinets are used to store valuables so they are not accessible to others. Traditional safes are exceedingly heavy and/or bulky and made of steel and/or concrete. These safes are often placed on a floor where people need to bend over to access their jewelry or other items stored in the safe.

Safes can be concealed under the floor of a building, such as in U.S. Pat. No. 4,625,658 (Hodges) and U.S. Pat. No. 1,584,294 (Heise). Other patents describe hidden locking compartments, such as U.S. Pat. No. 8,726,704 (White). Other patents, such as U.S. Pat. No. 4,022,137 (Chiu) and U.S. Pat. No. 9,078,531 (Medawar), describe cabinets that can be raised and lowered.

### SUMMARY

A principal object of the present disclosure is to provide a safe or locking cabinet that can be concealed in a piece of furniture.

Another object of the disclosure is to provide a concealed safe or locking cabinet that can be raised and lowered automatically.

A further object is to disguise a safe as a piece of furniture and to move the safe from a place of concealment to an accessible level and back again.

In accordance with the objects of the disclosure, a concealed high security locking safe is provided. The concealed locking safe comprises a lifting device within a hollow furniture piece and a locking safe on a platform of the lifting device wherein the locking safe is concealed within the hollow furniture piece and covered by a top of the hollow furniture piece.

Also in accordance with the objects of the disclosure, a method to conceal a locking safe in a furniture piece is provided. A lifting device is positioned within a hollow furniture piece. A locking safe is positioned on a platform of the lifting device wherein the locking safe is concealed within the hollow furniture piece. The locking safe is covered with a top of the hollow furniture piece. The lifting device is signaled to raise the locking safe to a position above the hollow furniture piece. A lock on a door of the locking safe is opened to access the contents. The lifting device is signaled to lower the locking safe into a concealed position within the hollow furniture piece.

Also in accordance with the objects of the disclosure, a method of using a concealed locking safe is achieved. A concealed locking safe is provided comprising a lifting device within a hollow furniture piece and the locking safe affixed to a platform of the lifting device wherein the locking safe is concealed within the hollow furniture piece and covered by a top of the hollow furniture piece. A user signals the lifting device to raise the locking safe to a position above the hollow furniture piece, opens a lock on a door of the locking safe to access contents of the locking safe, and signals the lifting device to lower the locking safe into the concealed position within the hollow furniture piece.

### BRIEF DESCRIPTION OF THE DRAWINGS

In the accompanying drawings forming a material part of this description, there is shown:

FIG. 1 schematically illustrates a concealing cabinet of the present disclosure.

FIG. 2 schematically illustrates a cut-away view of a safe concealed within the concealing cabinet of the present disclosure.

FIG. 3 schematically illustrates the underside of a top of the concealing cabinet of the present disclosure.

FIG. 4 schematically illustrates a cut-away view of a safe raised to a position above the concealing cabinet of the present disclosure.

FIG. 5 schematically illustrates the safe of the present disclosure with its door open.

FIG. 6 schematically illustrates a remote control, lift control, and power supply of the present disclosure.

FIG. 7A schematically illustrates a top view of a first alternative concealing cabinet of the present disclosure.

FIG. 7B schematically illustrates a safe of the first alternative concealing cabinet with its door open.

FIG. 8A schematically illustrates the underside of a top in a second alternative concealing cabinet of the present disclosure.

FIG. 8B schematically illustrates a safe of the second alternative concealing cabinet with its door open.

FIG. 9 schematically illustrates a safe of the present disclosure concealed within an art stand.

FIG. 10 schematically illustrates a cut-away view of a safe of the present disclosure concealed within a dresser.

### DETAILED DESCRIPTION

A safe or locking cabinet is provided that can be concealed in a piece of furniture in a home or office, for example. This may be a cabinet, end table, dresser, or any other type of furniture that can have a hollow inside area. A vertical lifting device is positioned inside the hollow area of the furniture. The safe is placed on and/or attached to the lifting device. The top portion of the furniture covers the safe.

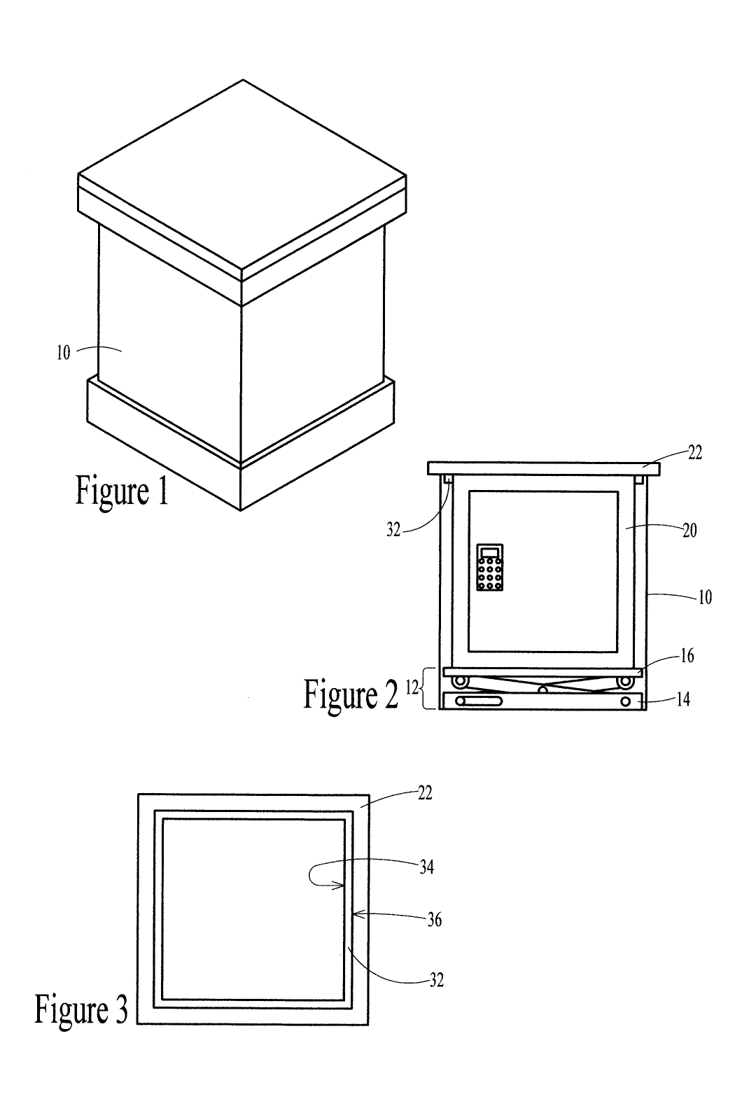

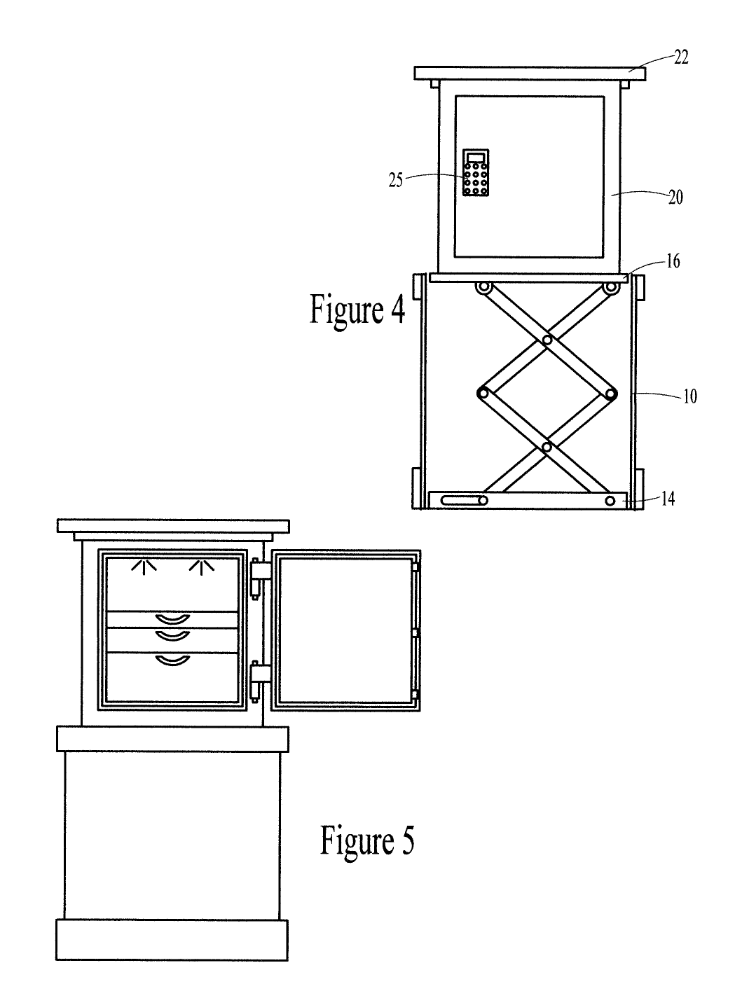

Referring now to FIGS. 1-6, the present disclosure will be described in more detail. FIG. 1 illustrates a piece of furniture 10; for example, a cabinet. FIGS. 2 and 4 illustrate cut-away views of the safe concealed within the cabinet 10. The safe is shown through the front of the cabinet in the drawings, but it is not actually visible through the cabinet. The safe will be completely hidden and concealed within the furniture. FIG. 2 shows a vertical lifting device 12 inside the hollow cabinet 10. The lifting device is preferably an electric scissor lift. The scissor lift can be, but is not limited to, a DXS Series Double Scissor Lift (Presto Lifts Inc, Norton, Mass.). The lifting device needs to have a sufficient load capacity, such as between 500 and 1000 pounds, to lift a standard safe and its contents. Various lift models are commercially available that have differing lift heights, such as 36″, 43″, or more, with the lifting height needed dependent on the height of the hollow furniture piece and the height of the safe.

The hollow furniture piece may have a bottom piece that sits on the floor of a room or it may not have a bottom piece, where the bottom edges of the side pieces of the furniture sit on the floor of the room and the floor area under the furniture is enclosed by the side pieces of the furniture. The lifting device 12 can be free-standing and positioned within the hollow cabinet or affixed to the inside of the cabinet, or directly to the floor, such as by bolting. Preferably, the base 14 of the lift can be bolted through the cabinet's bottom to the floor on which the cabinet stands. The safe can be positioned on the platform 16 of the lift or it can be affixed to the platform of the lift, such as by bolts or by welding.

Preferably, the lift is powered by a 110 volt plug-in motor. The lifting mechanism can be powered by hydraulic or pneumatic cylinders, for example, and can be controlled by either a wireless or wired controller.

The top of the furniture 22 preferably is attached to the top of the safe 20 by glue or other fasteners. In one preferred alternative, the underside of the top of the furniture is framed in order to fit on top of the safe. FIG. 3 illustrates the underside of the top 22. As shown in FIG. 3, wood framing 32 drops down from the bottom of the removable top 22 of the furniture. The inside surface 34 of this wood is directly around the top of the safe 20 itself whereas the outside surface 36 of the wood fits directly inside the hollow box 10, as shown also in FIG. 2.

The lift 12 is activated by pressing a button on a remote control that is wired to the lift and exits the furniture via a small hole on the back. Alternatively and preferably, the lift is operated by using a wireless remote control.

When the lift is activated, it raises the safe up out of the cabinet, preferably until the bottom of the safe rests at the height of the top of the furniture, as shown in FIG. 4. Now, the safe can be opened with the locking mechanism 25. Preferably, the locking mechanism has electronic or biometric controls. FIG. 5 shows an exemplary safe with the door 24 opened.

The safe can be connected to an alarm system with a seismic alarm, so when the safe shakes, it will alert the alarm company that the safe is being moved. This can be done using either the wired alarm connection coming out of the bottom of the safe, or through a wireless adapter. Alternatively, a duress alarm or a contact alarm indicating the safe has been raised can be connected. For example, there can be a dry door contact attached to the top of the concealment cabinet. Once that connection is separated (i.e. the safe is lifted), it will trigger the alarm. There will be a wire running from this contact to the central alarm connection.

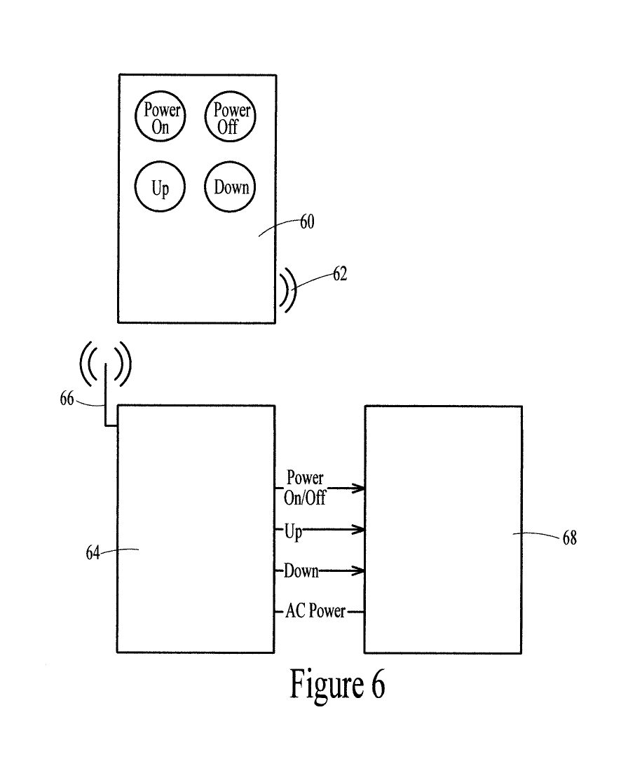

The concealed safe of the present disclosure can be accessed easily by the owner in the raised position. A press of a button on the lift or on the remote control will lower the safe into the furniture, thus concealing it again. Any appropriate remote control can be used, such as, but not limited to, a #TM2000 Telechief® Series Radio Remote Control (Control Chief Corporation, Bradford, Pa.). A receiver is connected to the lift control and the lift power supply to receive a signal from the remote control to raise or lower the safe. FIG. 6 illustrates an exemplary remote control 60 having push-button controls for power on and off and lift up and down. Pushing any of the control buttons sends a signal 62 to the receiver 66 of the lift control 64. The lift control is connected to the power supply 68 of the lift.

The safe and lifting device can be concealed within any appropriately sized hollow furniture piece, including furniture pieces specifically designed to accommodate the safe and lifting device or existing furniture pieces that can be modified to receive the safe and lifting device.

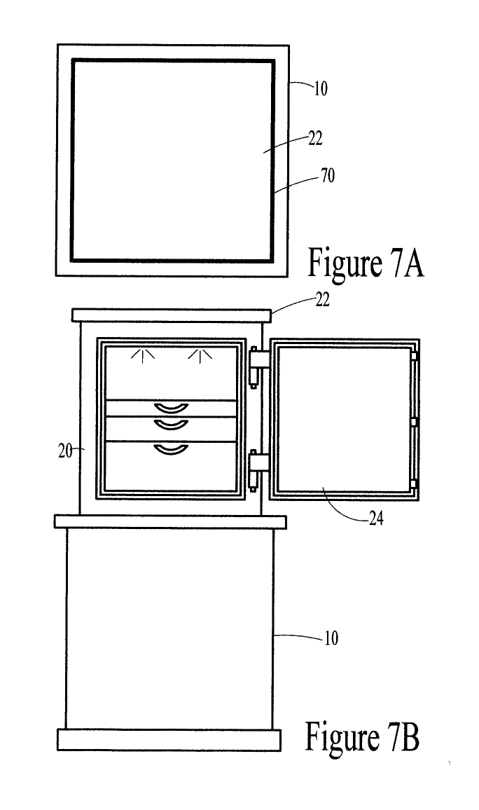

In an alternative embodiment, shown in FIGS. 7A and 7B, the top 22 is slightly smaller in length and width than the top opening in the cabinet. FIG. 7A illustrates a top view of the top of the cabinet 10. FIG. 7B illustrates a front view of the cabinet 10 with safe 20 raised and opened. When closed, the top 22 fits flush with the top edges of the cabinet. There will be a crack 70 of no more than about ⅛″ around the perimeter of the top opening between the top 22 and the sidewalls of the cabinet 10.

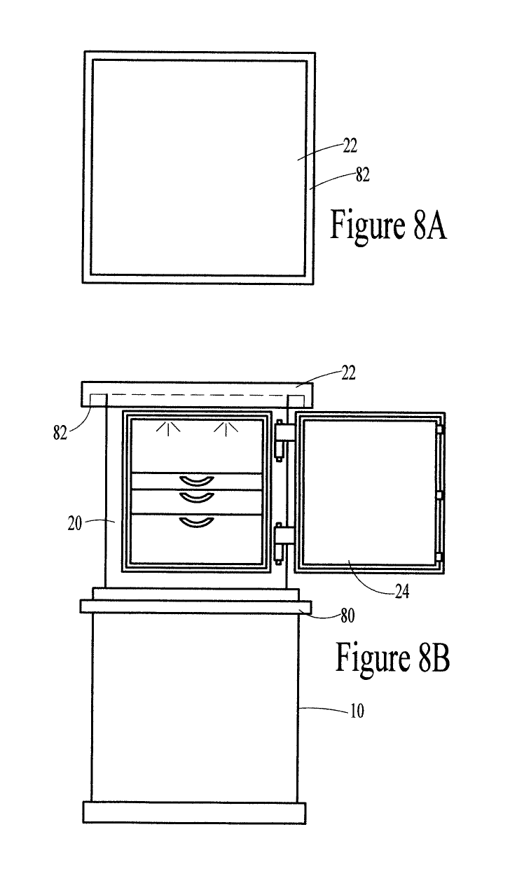

In another alternative, shown in FIGS. 8A and 8B, the cabinet 10 has a lip 80. FIG. 8A illustrates a top view of the top of the cabinet 10. FIG. 8B illustrates a front view of the cabinet 10 with safe 20 raised and opened. The top 22 is framed so that the frame 82 will fit around the outside surfaces of the cabinet walls and rest on the lip 80.

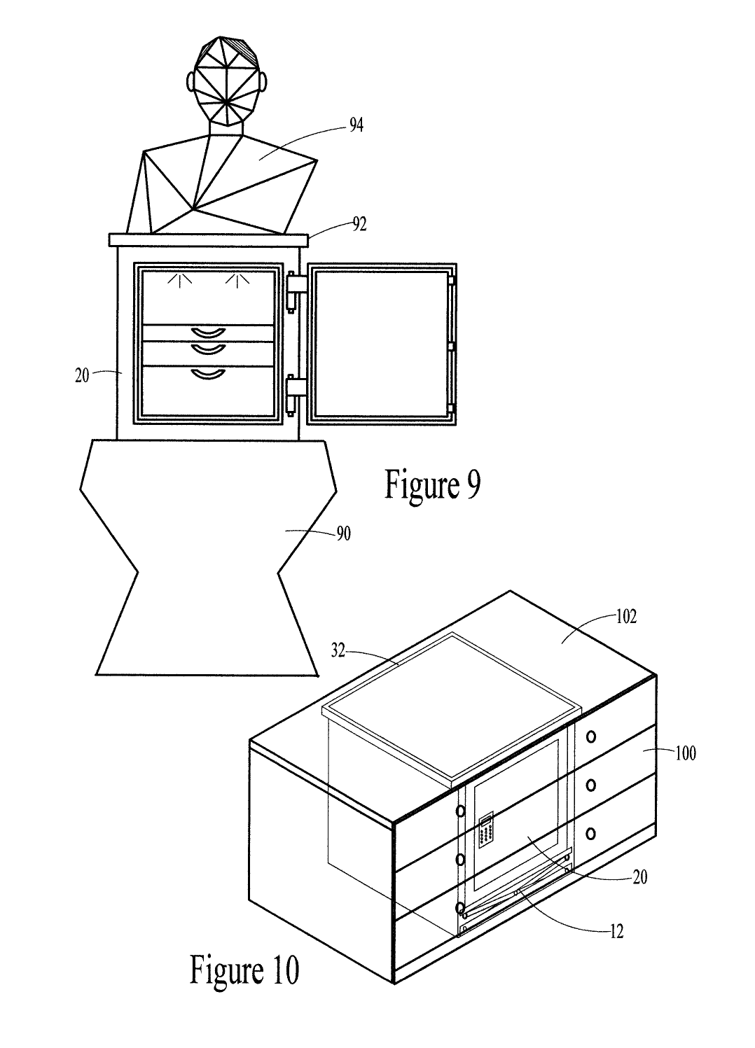

FIGS. 9 and 10 illustrate two of many other possibilities for types of concealing furniture for the safe and lifting device. FIG. 9 illustrates an art stand 90 having a top 92 on which an art piece 94 may be displayed. Safe 20 and lift, not shown, are concealed within the art stand. The safe 20 is shown in the raised position for access.

FIG. 10 illustrates a dresser 100 that may have been modified to hold the high security concealed locking safe. FIG. 10 shows the safe within the concealing furniture in a cut-away view. This is for illustration purposes only; the safe will not be visible through furniture in actuality, but will be completely hidden and concealed within the furniture. In order to modify the dresser, for example, the drawers are removed. The front panels of the drawers are glued in place on the front of the dresser. The safe 20 is placed on a lift 12 within the hollow dresser. The top 102 of the dresser is detached, framed 32, as shown in FIG. 3, for example, and affixed to the top of the safe so that the top 102 fits securely on the dresser body 100 when the safe is in the concealed position. Other possible concealing furniture pieces can be an island in a closet, an end table, a nightstand, a desk, and many other similar pieces.

Although the preferred embodiment of the present disclosure has been illustrated, and that form has been described in detail, it will be readily understood by those skilled in the art that various modifications may be made therein without departing from the spirit of the disclosure or from the scope of the appended claims.

What is claimed is:

1. A concealed locking safe comprising:
a vertical lifting device hidden inside a hollow furniture piece; and
a locking safe on a platform of said vertical lifting device wherein said locking safe is concealed within said hollow furniture piece and covered by a top of said hollow furniture piece.

2. The safe according to claim 1 wherein said vertical lifting device is a scissor lift.

3. The safe according to claim 1 wherein said lifting device is located on a floor of said hollow furniture piece or directly on a floor of a room under said hollow furniture piece.

4. The safe according to claim 1 wherein said vertical lifting device is bolted through a floor of said hollow furniture piece and into a floor of a room under said hollow furniture piece or said vertical lifting device is bolted into a floor of a room under a floorless said hollow furniture piece.

5. The safe according to claim 1 wherein said safe is bolted or welded to said platform of said vertical lifting device.

6. The safe according to claim 1 wherein said top of said hollow furniture piece is affixed to a top of said safe and wherein said top of said hollow furniture piece is framed on an underside so that an inside surface of said frame fits adjacent to said safe and an outside surface of said frame fits inside walls of said hollow furniture piece when said safe is concealed within said hollow furniture piece.

7. The safe according to claim 1 wherein said top of said hollow furniture piece is affixed to a top of said safe and wherein said top of said hollow furniture piece is slightly smaller than the inside measurements of walls of said hollow furniture piece so that said top of said hollow furniture piece fits flush with a top surface of said walls of said hollow furniture piece when said safe is concealed within said hollow furniture piece.

8. The safe according to claim 1 wherein said top of said hollow furniture piece is affixed to a top of said safe and wherein said top of said hollow furniture piece is framed so that an inside surface of said frame fits adjacent to an outside surface of walls of said furniture piece and rests on a lip on said outside surface of said walls when said safe is concealed within said hollow furniture piece.

9. The safe according to claim 1 wherein movement of said vertical lifting device is controlled by a wireless remote control.

10. The safe according to claim 1 wherein said vertical lifting device is configured to lift said safe sufficiently above a top surface of said hollow furniture piece so that a safe door can be opened, and to lower said safe into a concealed position within said hollow furniture piece.

11. A method to conceal a locking safe in a furniture piece comprising:
providing a hollow furniture piece;
positioning a lifting device within said hollow furniture piece;
positioning a locking safe on a platform of said lifting device wherein said locking safe is concealed within said hollow furniture piece; and
covering said locking safe with a top of said hollow furniture piece.

12. The method according to claim 11 wherein said lifting device is a scissor lift.

13. The method according to claim 11 further comprising:
signaling said lifting device to raise said locking safe to a position above said hollow furniture piece;
opening a lock on a surface of said locking safe to access contents of said locking safe; and
signaling said lifting device to lower said locking safe into a concealed position within said hollow furniture piece.

14. The method according to claim 11 wherein signaling of said lifting device is performed by a wireless remote control.

15. The method according to claim 11 wherein said positioning said lifting device within said hollow furniture piece comprises bolting a base of said lifting device through a floor of said hollow furniture piece and into a floor of a room under said hollow furniture piece or bolting said base directly into a floor of a room under said hollow furniture piece.

16. The method according to claim 11 wherein said positioning said locking safe on said platform of said lifting device comprises bolting or welding said locking safe to said platform of said lifting device.

17. The method according to claim 11 wherein said covering said locking safe with a top of said hollow furniture piece comprises affixing said top of said hollow furniture piece to a top of said safe.

18. The method according to claim 11 further comprising:
connecting said locking safe to a seismic alarm system wherein an alarm is triggered if said locking safe is moved.

19. A method of using a concealed locking safe comprising:
providing a concealed locking safe comprising:
a lifting device within a hollow furniture piece; and
said locking safe on a platform of said lifting device wherein said locking safe is concealed within said hollow furniture piece and covered by a top of said hollow furniture piece;
signaling said lifting device to raise said locking safe to a position above said hollow furniture piece;
opening a lock on a door of said locking safe to access contents of said locking safe; and
signaling said lifting device to lower said locking safe into a concealed position within said hollow furniture piece.

20. The method according to claim 19 wherein said lifting device is a scissor lift.
